(19) United States
(12) Patent Application Publication
(10) Pub. No.: US 2007/0078747 A1
(43) Pub. Date: Apr. 5, 2007

(54) System and method for providing bidding on real estate among previously identified parties.

(76) Inventor: James H. Baack, Piedmont, CA (US)

Correspondence Address: JAMES H. BAACK, 1881 TRESTLE GLEN ROAD, PIEDMONT, CA, 94610, US

(21) Appl. No.: 11/162,902

(22) Filed: Sep. 28, 2005

(51) Int. Cl. G06Q 40/00

(52) U.S. Cl. 705/37

(57) ABSTRACT

A system and method for providing bidding on real estate among previously identified parties. The system includes one or more servers storing and providing information about the real estate to be bid on; one or more means to invite pre-identified potential bidders to bid on each piece of real estate; one or more means for only those invited bidders to connect to the system and submit bids; and a series of rules to determine the preferred bid from amongst those submitted. The method operates by providing a way for properties to be submitted to be bid upon, specifically inviting known bidders to bid on each piece of real estate, allowing only those bidders to communicate their bids, accepting bids during the defined bidding period and determining a preferential ordering of the received bids.

### CROSS REFERENCE TO RELATED APPLICATIONS

This application claims priority to and the benefit of co-pending U.S. provisional patent application entitled “An Auditable, Private Bidding System Used By Trusted Parties to Achieve Efficient Market Pricing For the Sale of Real Estate” filed on Sep. 29, 2004 and accorded Ser. No. 60/522418 which is incorporated herein by reference.

### FIELD OF THE INVENTION

This invention relates to methods of selling real estate, and in particular to on-line bidding for real estate among pre-identified parties.

### BACKGROUND OF THE INVENTION

Currently, many pieces of real estate receive multiple, competing offers from various interested buyers. The price and conditions associated with each offer may vary. Sellers must go through a complex, formal process to respond to, or counter-offer, one or more of the buyers who submitted offers. Other buyers may be willing to increase their offer but have no opportunity to without a counter-offer from the seller. In addition, buyers normally are unaware of the prices being offered by other buyers and may be reluctant to offer too much and overpay for the real estate.

### SUMMARY OF THE INVENTION

The invention provides a method and system to address these shortcomings by providing bidding on real estate by previously identified potential buyers. Interested potential buyers are known to the seller as those previously submitting a formal purchase offer or other document. Once the real estate is registered for bidding, invitations to bid are extended to these potential buyers. They are allowed to access the property and submit bids—no access or bidding is permitted by anyone else. Bids are accepted during a defined bidding period, during which time a continual priority ordering of the bids is maintained. At the end of the bidding period the winning bid and associated bidder are identified.

The invention improves upon current practice by providing a simpler and more efficient method for arriving at a final purchase price when multiple buyers are interested in a single piece of real estate. Furthermore, the transparent pricing provided by the bidding mechanism can result in increased confidence on the part of potential buyers as to the validity of their own purchase offer price.

### BRIEF DESCRIPTION OF THE DRAWINGS

The invention can be better understood with reference to the following drawings. The components in the drawings are not necessarily to scale, emphasis instead being placed upon clearly illustrating the principles of the invention.

FIG. 1 is a diagram showing the components and steps of the method and system of the invention.

FIG. 2 is a diagram showing the architectural components of the preferred embodiment of the system of the invention.

### DETAILED DESCRIPTION OF THE INVENTION

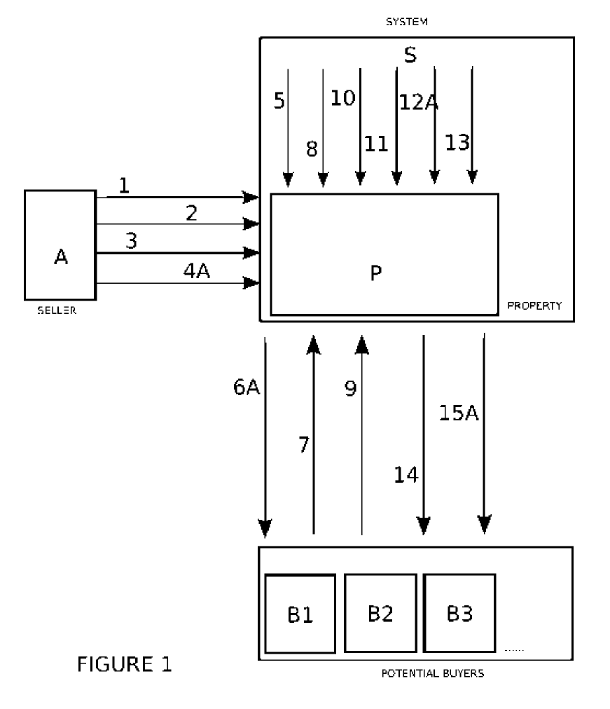

Turning now to the drawings, FIG. 1 is a diagram showing the components and steps of the method and system of the invention. The seller A interacts with the system S to initiate bidding on property P from potential buyers B1,B2,B3, etc. (there is no limit on the number of potential buyers and bidders). Steps are listed in roughly chronological order, considering the process in its normal progression. Step names post-pended with an ‘A’ are optional.

The seller A in step 1 connects to system S using a secure login mechanism.

The seller A in step 2 accesses system S and creates an entry for property P. This includes an identifier for the property, probably address, a bidding period and a starting bid amount.

The seller A in step 3 accesses system S and creates entries for potential buyers of property P—B1,B2,B3, etc. These entries include public and private identifiers for each bidder, and optionally a means to automatically contact each bidder to initiate bidding.

Optionally, the seller A in step 4A accesses system S and augments entries for one or more of potential buyers B1,B2,B3, etc. The entered information provides a means to calculate relative valuation of bids from the corresponding potential buyer and is based on the terms and conditions of any documented offer previously received from that potential buyer. In practice, this will be used to account for differences in financing terms, contingencies, closing periods and other variations in competing offers. This relative valuation may provide for fixed dollar amount and/or percentage adjustments to the actual bid amount.

The system S in step 5 creates secure login information for each potential buyers B1,B2,B3, etc. created in step 3. This information will be used by each potential buyer to connect to system S and may be transmitted to them automatically by system S (step 6A) or manually by some other means.

Optionally, the system S in step 6A contacts one or more of potential buyers B1,B2,B3, etc. to alert them to the fact that they will be eligible to bid on property P and to communicate the bidding specifics including bid period, starting bid amount and how they can connect to system S to conduct the bidding.

Potential buyers B1,B2,B3, etc. in step 7 connect to system S using a secure login mechanism and providing the identification information generated by system S in step 5.

The system S in step 8 opens the bidding once the bidding period defined in step 2 has begun.

Potential buyers B1,B2,B3, etc. in step 9 access the system and submit bids, as desired. Bids consist of a bid amount representing the purchase price to be paid by the bidder for property P.

The system S in step 10 evaluates and orders incoming bids from potential buyers B1,B2,B3, etc. Bids of higher amounts are given higher priority than lower amounts. Bids of equal amount are prioritized by time of submission—earlier submission is higher priority. Optionally, if optional step 4A was conducted, bid amounts will be prioritized in relation to each other based on the relative valuation information as entered in step 4A.

The system S in step 11, based on the ordering of bids achieved in step 10, determines the timing and amount of bids that will be required from potential buyers B1,B2,B3, etc. as the bidding period progresses. This information is made available to potential buyers B1,B2,B3, etc.

Optionally, the system in step 12A may apply bidding rules or algorithms that differ from standard auction rules to provide a bidding process that is specifically customized for more effective bidding on real estate. This may include allowing additional bids below an established top bid within a defined period of time and other adjustable rules.

Steps 9, 10, 11, 12 occur multiple times and continually within the defined bidding period.

The system S in step 13 determines that the bidding period has ended. Access to system S for the purpose of submitting bids on property P is suspended.

The system S in step 14 makes a final prioritization of the received bids, applying the same rules as in step 10. A top bid and corresponding potential buyer B1 or B2 or B3, etc. is determined. The information on the winning bidder and bid is made available to potential buyers B1,B2,B3, etc.

Optionally, the system S in step 15A creates an audit report of the bidding process on property P. This report details the list of potential buyers B1,B2,B3, etc. (using the public identifiers entered for each in step 3) and the bidding activity consisting of bid amount and time submitted. This audit report can be submitted to one or more of the seller A and potential buyers B1,B2,B3, etc.

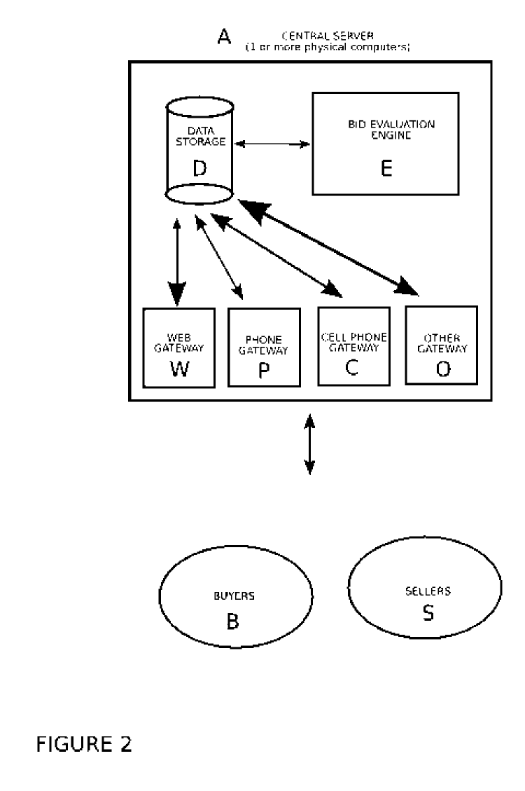

Turning to the next drawing, FIG. 2 is a diagram showing the architectural components of the preferred embodiment of the system of the invention.

The central server A represents the interconnected system components—they may reside in one or more physical computers.

Data storage D is some form of data store used to capture all persistent data about the property to be bid upon, the potential buyers and each bid submitted. The ideal physical storage mechanism to support D is a hard disk drive, periodically backed-up to tape or optical media.

Bid evaluation engine E are the rules used to examine, evaluate and prioritize the received bids, and to determine timing and amount of the bids that will next be required. This engine will utilize a CPU operating with central memory and will have read/write access to data storage D.

Web gateway W provides a connection from the Internet's World Wide Web to data storage D. This provides a mechanism for web users (sellers and buyers) to securely access and use the system.

Optional phone gateway P provides a connection from the public switched telephone network to data storage D. This provides a mechanism for phone users to securely access and use the system.

Optional cellular gateway C provides a connection from one or more cellular phone systems to data storage D. This provides a mechanism for cellular phone users (sellers and buyers) to securely access and use the system.

Optional other gateway O provides a connection from another, as yet undefined, communications network to data storage D. This provides a mechanism to add to the system additional convenient forms of access for users (sellers and buyers).

Potential buyers B and sellers S are represented as a cloud external to the core system. Access to the system is provided through the gateways as described above.

What is claimed is:

1. A method for providing a real estate bidding system where each potential buyer is specifically invited by the seller to participate in bidding, comprising the steps of: posting a real estate property for bidding; inviting one or more potential bidders known or thought by the seller to be interested in the property to participate in the bidding; provide one or more methods for only these invited bidders to communicate their bids; accept bids from one or more bidders during a defined bidding period; and to determine from amongst the received bids a priority ordering that identifies the winning bidder.

2. The method of claim 1, further comprising the step of: providing the seller one or more methods for adjusting the relative valuations of received bids based on the previously submitted purchase conditions submitted by the corresponding bidders.

3. The method of claim 1, further comprising the step of: providing bidding rules, or algorithms, that differ from standard auction rules to provide a bidding process that is specifically customized for more effective bidding on real estate.

4. The method of claim 1, further comprising the step of: after the conclusion of the bidding, providing a report detailing the bidding process, including each and every bid, making possible the auditing of the bidding process by the seller and each bidder.

5. A system for providing a real estate bidding system where each potential buyer is specifically invited by the seller to participate in bidding, comprising: means for posting a real estate property for bidding; means for inviting one or more potential bidders known or thought by the seller to be interested in the property to participate in the bidding; means for providing one or more methods for only these invited bidders to connect to the bidding system; means for accepting bids from one or more bidders during a defined bidding period; and means for determining from amongst the received bids a priority ordering that identifies the winning bidder.

6. The system of claim 5, further comprising: means for providing the seller one or more methods for adjusting the relative valuations of received bids based on the previously submitted purchase conditions submitted by the corresponding bidders.

7. The system of claim 5, further comprising: means for providing bidding rules, or algorithms, that differ from standard auction rules to provide a bidding process that is specifically customized for more effective bidding on real estate.

8. The system of claim 5, further comprising: means for, after the conclusion of the bidding, providing a report detailing the bidding process, including each and every bid, making possible the auditing of the bidding process by the seller and each bidder.
